(19) United States
(12) Patent Application Publication
(10) Pub. No.: US 2002/0123002 A1
(43) Pub. Date: Sep. 5, 2002

(54) Method for decorating molding

(75) Inventors: Mikio Masui, Osaka (JP); Keiji Higashi, Nara (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MATSUSHITA ELECTRIC WORKS, LTD., Kadoma-shi, Osaka (JP)

(21) Appl. No.: 09/984,140

(22) Filed: Oct. 29, 2001

(30) Foreign Application Priority Data
Dec. 25, 2000 (JP) P2000-393872

(51) Int. Cl. G03C 5/00

(52) U.S. Cl. 430/269; 430/945; 430/320

(57) ABSTRACT

A coating film 2 of an uncured resin composition which is curable in response to irradiation with an energy beam is formed on the surface of a molding 1. A desirable portion of the coating film 2 is irradiated with the energy beam. Thus, the portion of the coating film 2 irradiated with the energy beam is cured to form a surface decorative layer 3.

This application is based on a Japanese Patent Application 2000-393872 filed on Dec. 25, 2000, herein cooperated by reference.

### BACKGROUND OF THE INVENTION

1. Field of Invention

The present invention relates to a method for decorating a molding, in which desirable characters, patterns, graphics, and so on, are formed on the surface of a molding such as a housing of an electrical apparatus such as a shaver or a drier, or a household article such as tableware, so as to decorate the surface of the molding.

2. Related Art

In order to indicate an instruction manual on the surface of a molding such as an electrical apparatus, a household article, or the like, made of a synthetic resin material, metal, ceramics, or the like, or in order to improve the design of the mold, desirable characters, patterns, graphics, and so on, may be formed on the surface of the mold so as to decorate the surface of the molding.

Conventionally, when such decoration is applied to the surface of a molding, there has been carried out a method for painting with a solvent paint such as lacquer painting or the like; a method for painting in such a manner that a coating film of a paint composed of thermosetting resin or the like is disposed in a high-temperature atmosphere to be thereby heated to form a film; a method in which a film decorated with characters or the like is pasted to the molding; a method in which decoration formed in a film is transferred to the molding; or the like.

However, in the case of painting with a solvent paint, there has been a problem that working environment deteriorates due to a solvent used therein, and natural environment is also adversely affected.

In addition, in the case of using a paint composed of thermosetting resin or the like, there has been a problem that it takes much time to cure the paint when the molding is disposed in a high-temperature atmosphere, so that line production is difficult.

Further, in the method of film pasting, film transfer, or the like, there has been a problem that a film which is a member separate from the molding is required so that the manufacturing cost increases. In addition, in the case of the film transfer, there has been a problem that it is necessary to dispose of the film waste to thereby cause negative environmental influence.

Moreover, Conventional method for Curing Thermosetting Material is such that the material is kept in a mold at a hundred and several tens of degrees for several minutes or several tens of minutes so as to be cured. For example, it is known an IMC (In-Mold Coating) molding method which is a method for forming a coating layer as a thin film on a molding.

### SUMMARY OF THE INVENTION

The present invention was developed in consideration of the foregoing problems. It is an object of the present invention to provide a method for decorating a molding in which line production is easy, environmental deterioration can be prevented, working efficiency is excellent, and the molding can be decorated with desirable characters or the like without requiring any separate member such as a film or the like. Specially, an energy beam is used for curing a resin as thermosetting resin.

According to a first aspect of the present invention, a coating film is formed out of an uncured resin composition on the surface of the molding. The resin composition is curable in response to irradiation with an energy beam. A desirable portion of the coating film is irradiated with the energy beam so that the portion of the coating film irradiated with the energy beam is cured to form a surface decorative layer. Thus, without heating the coating film with a mold, a jig, or the like, the coating film can be cured to form a surface decorative layer by the irradiation with the energy beam in a short time. Thus, the molding can be decorated with desirable characters, graphics, etc. In addition, such a surface decorative layer can be formed only in a portion requiring decoration in the molding while a separate member such as a film or the like is not required. Thus, decoration can be made at a low cost. In addition, when the surface decorative layer is formed, the processing such as irradiation with an energy beam or the like is applied only to the coating film. Thus, the surface decorative layer can be formed without giving any influence to the material forming the molding. Accordingly, decoration can be made on moldings of various materials. In addition, molding the molding and forming the surface decorative layer can be arranged in a series of lines. Thus, the manufacturing efficiency of the molding on which the surface decorative layer is formed is high. In addition, there is no fear that any solvent component is not evaporated when the surface decorative layer is formed. Thus, environmental deterioration can be prevented.

According to a second aspect of the present invention, a resin composition to which a coloring material for coloring in a single color or a plurality of colors in response to irradiation with a specific energy beam has been added is used as the resin composition. Thus, a desirable portion of a coating film is irradiated with the energy beam so that the portion of the coating film irradiated with the energy beam is colored and cured simultaneously to thereby form a surface decorative layer. Accordingly, by coloring the surface decorative layer in a single color or a plurality of colors, colorful decoration can be made. In addition, since the coating film can be cured and colored simultaneously so as to form the surface decorative layer, it is possible to form the surface decorative layer in a short time.

According to a third aspect of the present invention, a resin composition to which a coloring material for coloring in a single color or a plurality of colors in response to irradiation with a specific energy beam has been added is used as the resin composition. Then, a desirable portion of a coating film is irradiated with an energy beam which will not color the coloring material. Thus, the portion of the coating film irradiated with the energy beam is cured to form a surface decorative layer. After that, a desirable portion of the surface decorative layer is irradiated with an energy beam which can color the coloring material. Thus, the portion irradiated with the energy beam is colored. Accordingly, by coloring the surface decorative layer in a single color or a plurality of colors, colorful decoration can be made.

According to a fourth aspect of the present invention, a plurality of surface decorative layers are formed to be laminated on the surface of a molding. Thus, characters, patterns, graphics, etc., composed of different colors are formed in the laminated surface decorative layers respectively. In addition, such patterns, etc., can be formed to be superimposed on each other. Thus, by the combination of the patterns, etc., formed in the respective surface decorative layers, complicated and colorful decoration can be made.

According to a fifth aspect of the present invention, a transparent resin layer is formed as an outer layer of a surface decorative layer. Accordingly, the surface decorative layer can be protected by the transparent resin layer. Thus, the surface decorative layer is prevented from damage or peeling, so that the decoration shown in the surface decorative layer can be kept for a long term while the decoration shown in the surface decorative layer can be recognized visually through the transparent resin layer easily.

According to a sixth aspect of the present invention, a thermosetting resin composition is used as the resin composition, and a heating accelerator is compounded in the thermosetting resin composition. Accordingly, heat generation of a coating film of the resin composition is accelerated when the coating film is irradiated with an energy beam. Thus, the coating film can be cured to form a surface decorative layer in a short time, so that the working efficiency can be improved.

According to a seventh aspect of the present invention, a recess portion is formed in the surface of a molding, and a surface decorative layer is formed in the recess portion. Accordingly, the surface decorative layer having the same shape as that of the recess portion can be formed easily. Thus, if the shape of the recess portion is formed into a desired shape of the surface decorative layer in advance, the surface decorative layer with the desired shape can be formed easily. In addition, the surface decorative layer formed in the recess portion can be formed not to project from the surface of the molding. Thus, the surface decorative layer can be prevented from damage due to abrasion or from peeling.

According to an eighth aspect of the present invention, a desirable portion of a coating film composed of a resin composition is irradiated with an energy beam to be cured to thereby form a surface decorative layer. After that, an uncured portion of the coating film is removed. Thus, the surface decorative layer having a desired shape can be formed without performing processing such as forming a recess portion in a molding.

According to a ninth aspect of the present invention, a light-transmitting member is disposed in contact with the surface of a coating film composed of a resin composition, and the coating film is irradiated with an energy beam through the light-transmitting member so as to be cured. Accordingly, during the process in which the coating film is cured, the light-transmitting member is in contact with the surface of the coating film or the surface of a surface decorative layer formed by the cured coating film. Thus, the thickness of the coating film or the thickness of the surface decorative layer is controlled by the light-transmitting member so that the surface decorative layer can be formed to have a desired thickness. In addition, at this time, the surface decorative layer can be formed to be smooth.

According to a tenth aspect of the present invention, a resin composition curable by radical polymerization is used as the resin composition. Then, a coating film is irradiated with an energy beam so as to be cured in a vacuum or in an inert atmosphere. Accordingly, during the process in which the coating film of the resin composition is cured by radical polymerization, oxygen or the like which may inhibit the radical polymerization is prevented from being supplied to the coating film, so that the reaction efficiency of the radical polymerization is improved. Thus, the coating film of the resin composition can be cured to form a surface decorative layer in a shorter time.

According to an eleventh aspect of the present invention, a surface decorative layer is formed to be 0.1 to 100 μm thick. Accordingly, when a coating film is cured to form the surface decorative layer, the curing is accelerated so that the coating film can be formed efficiently in a short time. In addition, sufficient strength is given to the surface decorative layer so that abrasion can be reduced, or the adhesive property between the surface decorative layer and a molding can be improved. In addition, the surface decorative layer is formed not to be thicker than necessary, so that the manufacturing cost can be reduced.

According to a twelfth aspect of the present invention, a coating film is formed out of a resin composition having its viscosity adjusted to be in a range of from 0.1 Pa·s to 1,000 Pa·s. Accordingly, sufficient fluidity of the resin composition can be ensured to form the coating film satisfactorily, and sufficient viscosity can be ensured to keep the thickness of the coating film. In addition, particularly, in the case where a recess portion is formed in a molding and a surface decorative layer is formed in the recess portion, even if the recess portion is formed to have a narrow width, the resin composition can be still made to flow in the recess portion satisfactorily at the time when the resin composition is injected into the recess portion. Thus, the coating film can be formed in the recess portion easily. Accordingly, it is possible to prevent a situation that the resin composition does not reach every part of the inside of the recess portion so that the surface decorative layer cannot be formed to have a sufficient thickness.

According to a thirteenth aspect of the present invention, a molding molded out of synthetic resin described above. Accordingly, an excellent adhesive property is provided between the molding and a surface decorative layer which is formed out of a coloring composition composed of a resin composition. Thus, the adhesive strength of the surface decorative layer can be improved.

### BRIEF DESCRIPTION OF DRAWINGS

FIGS. 1(a) to (c) are plan views showing an example in a mode for carrying out the present invention.

FIG. 2(a) to 2(d) are plan views showing another example in the mode for carrying out the present invention.

FIGS. 3(a) and (b) are plan views showing a further example in the mode for carrying out the present invention, FIGS. 3(c) and (d) are plan views showing another mode.

FIGS. 4(a) and (b) are plan views showing a further example in the mode for carrying out the present invention, and FIGS. 4(c) and (d) are plan views showing the another mode.

FIGS. 5(a) to (c) are plan views showing a further example in the mode for carrying out the present invention.

FIGS. 6(a) to (d) are views showing a further example in the mode for carrying out the present invention, FIGS. 6(a) and (c) being plan views, FIGS. 6(b) and (d) being sectional views of FIGS. 6(a) and (c) respectively.

FIGS. 7(a) to (f) are views showing a further example in the mode for carrying out the present invention, FIGS. 7(a), (c) and (e) being plan views, FIGS. 7(b), (d) and (f) being sectional views of FIGS. 7(a), (c) and (e) respectively.

FIGS. 8(a) to (f) are views showing a further example in the mode for carrying out the present invention, FIGS. 8(a), (c) and (e) being plan views, FIGS. 8(b), (d) and (f) being sectional views of FIGS. 8(a), (c) and (e) respectively.

FIG. 9 is a sectional view showing a further example in the mode for carrying out the present invention.

FIG. 10 is a sectional view showing a further example in the mode for carrying out the present invention.

FIG. 11 is a sectional view showing a further example in the mode for carrying out the present invention.

### DETAILED DESCRIPTION OF PREFERRED EMBODIMENTS

A mode for carrying out the present invention will be described below.

A surface decorative layer 3 provided on the surface of a molding 1 according to the present invention can be formed by irradiating an uncured resin composition with an energy beam.

Resin which is curable by irradiation with a suitable energy beam such as an electron beam, a laser beam, infrared rays, ultraviolet rays, or the like, is used as the uncured resin composition. Resin mixed with a filler, a polymerization initiator, a curing accelerator, and so on, as resin components in accordance with necessity may be used. For example, if thermosetting resin is used as a resin component, a thermosetting resin composition which is curable by heating based on irradiation with an energy beam such as a laser beam or the like can be prepared. When a resin composition is thus prepared as a thermosetting resin composition, unsaturated polyester resin, vinyl ester resin, urethane acrylate resin, two-part urethane resin, etc., may be used as the thermosetting resin. Two or more kinds of such thermosetting resins may be used together as well as only one kind may be used.

In addition, this resin composition may contain coloring matters so that the resin composition can be colored. Suitable pigments, dyestuffs, or the like, such as titanium dioxide, antimony trioxide, iron oxide, chromium oxide, cadmium sulfide, antimony trisulfide, carbon black, azo compounds, metallic salts, etc., can be used as such coloring matters.

Here, as such coloring matters, one or more kinds of coloring matters may be used in mixture so as to apply a specific color to the resin composition. As such a resin composition, a thermoplastics IMC agent (pragrass #8000 Green) made by DAI NIPPON TORYO CO., LTD. can be mentioned by way of example. This agent is a mixture of 100 parts by mass of a base agent and 2 parts by mass of a curing agent. The base agent is composed of 68% by mass of urethane acrylate (containing a crosslinker and a polymerization inhibitor), 30% by mass of an inorganic compound as pigment (cobalt oxide), and 2% by mass of additives such as a pigment dispersant, an internal mold release agent, etc. The curing agent is composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate).

By use of such a resin composition provided with a special color, the surface decorative layer 3 is formed on the surface of the molding 1 so that decoration of the molding 1 or the like can be carried out. As the molding 1, a molding made of synthetic resin such as thermoplastic resin or thermosetting resin, or a molding made of metal, ceramics, or the like, can be used. Particularly if the molding 1 molded out of synthetic resin is used, an excellent adhesive property is provided between the molding 1 and the surface decorative layer 3 formed out of the resin composition so that the adhesive strength of the surface decorative layer 3 can be improved.

Method for forming a surface Decorative Layer could be employ as follows:

Injection Method Using a Dispenser or the Like:

Suitable for forming a comparatively thick decorative layer in a recess portion or the like, and it is suitable for forming a decorative layer on a complicated and minute structure.

Spraying Method:

It is suitable for forming a decorative layer having a large area.

Printing Method (Screen, Tampo)

It is suitable for forming a decorative layer on a comparatively thin and planar structure.

To decorate the molding 1 with the resin composition, the resin composition as described above is first applied to a portion to be decorated on the surface of the molding 1, so as to form a coating film 2, as shown in FIG. 4(a). Next, a desirable portion of the coating film 2, for example, an area having a square shape, in plan view, in the coating film 2 as shown in FIG. 4(b), or an area having a circular shape, in plane view, in the coating film 2 as shown in FIG. 4(d), is irradiated with a laser beam so as to be cured to form the surface decorative layer 3 in this cured portion.

A suitable energy beam may be used at this time if it can promote the curing reaction of the resin composition to thereby cure the coating film 2 of the resin composition. An electron beam, a laser beam, infrared rays, ultraviolet rays, etc. may be used in accordance with the kind of resin composition. For example, when the resin composition is prepared as thermosetting resin, the coating film 2 can be heated and cured by irradiation with a laser beam, infrared rays, or the like. Alternatively, when the resin composition is prepared as ultraviolet-curing resin, the coating film 2 can be cured by irradiation with ultraviolet rays. By way of specific example, when the thermosetting resin composition described above specifically is used as the resin composition, irradiation with a laser beam can be carried out by use of a semiconductor laser oscillating apparatus made by Spectra-Physics Inc. under the conditions of wavelength 795 nm, CW (Continuous Wave) oscillation, output 2.5 W, spot diameter ø1.5 mm, scanning speed 2.5 mm/sec, and irradiation time 0.6 sec.

The surface decorative layer 3 formed thus is formed to be adhered to the surface of the molding 1 so that a suitable color corresponding to the color matters compounded in the resin composition is provided.

Here, when the coating film 2 is irradiated with an energy beam, the coating film 2 is wholly irradiated with the energy beam so as to be wholly cured. Thus, the coating film 2 as a whole can be formed as the surface decorative layer 3. Alternatively, as shown in FIG. 4(b) or 4(d), only a desired portion of the coating film 2 is partially irradiated with the energy beam so that the surface decorative layer 3 can be formed to have a desired shape.

When the surface decorative layer 3 having a desired shape such as a square shape, a circular shape, or the like has been formed by partial irradiation with the energy beam as shown in FIG. 4(b) or FIG. 4(d), air or a water flow is sprayed from a nozzle toward the uncured coating film 2 so as to remove an uncured portion of the coating film 2. Thus, the surface decorative layer 3 can be left as a relief on the molding 1 as shown in FIG. 4(c) or FIG. 4(e).

When the resin composition is prepared, a coloring material which can color in a single color or in a plurality of colors in response to irradiation with an energy beam may be used. In this case, such a coloring material may be added to the resin composition as described above.

As the coloring material, for example, photoreactive multi-coloring matters which can color in response to irradiation with an energy beam of a specific wavelength, chemically reactive multi-coloring matters which can color based on an oxidation-reduction reaction, or thermally reactive multi-coloring matters which can color in response to the supply of thermal energy may be used.

Such a coloring material can be prepared by mixing a plurality of kinds of coloring matters having light absorptive power which is reduced or lost, for example, in response to irradiation with light of a specific wavelength to thereby make the coloring power of the coloring matters be lost. By way of specific example, 5 parts by mass of titanium dioxide pigment (made by TOIFINE LTD., Holland; Toifine R41), 0.05 parts by mass of magenta pigment (made by CIBA-GEIGY LTD., Holland; Irgalith Rubine 4BP), 0.05 parts by mass of cyan pigment (made by CIBA-GEIGY LTD., Holland; Irgalith blue LGLD), and 0.05 parts by mass of yellow pigment (made by CIBA-GEIGY LTD., Holland; Cromophal Yellow 6G) may be mixed to prepare a coloring material. The coloring material described here by way of example is black or gray when it has not been irradiated with a laser beam of a specific wavelength. However, the coloring material colors in blue in response to irradiation with a laser beam having a wavelength of 470 nm, colors in yellow in response to irradiation with a laser beam having a wavelength of 575 nm, and colors in orange in response to irradiation with a laser beam having a wavelength of 650 nm.

As a specific example of the resin composition containing such a coloring material, the above-mentioned thermoplastics IMC agent (Plaglass #8000 Green) made by DAI NIPPON TORYO CO., LTD. can be mentioned, providing that a coloring material as described above has been compounded in place of the pigments. That is, the resin composition is a mixture of 100 parts by mass of a base agent and 2 parts by mass of a curing agent. The base agent is composed of 68% by mass of urethane acrylate (containing a crosslinker and a polymerization inhibitor), 30% by mass of the above-mentioned coloring material, and 2% by mass of additives such as a pigment dispersant, an internal mold release agent, etc. The curing agent is composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate).

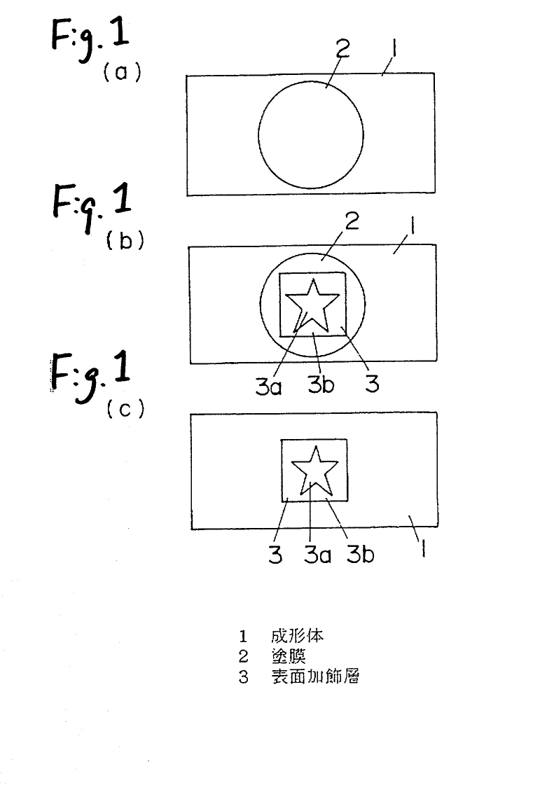

When the molding 1 is decorated by use of the resin composition compounded with such a coloring material, first, as shown in FIG. 1(a), the resin composition is applied to a portion to be decorated on the surface of the molding so as to form the coating film 2. Next, a desirable portion of the coating film 2, for example, an area having a square shape, in plan view, in the coating film 2 shown in FIG. 1(b) is irradiated with an energy beam so as to be cured. Thus, the surface decorative layer 3 is formed in this cured portion.

As the energy beam at this time, a suitable one may be used if it can color the resin composition in a desired portion so as to change the color into a desired color and if it promotes the curing reaction of the resin composition. For example, when the resin composition is composed of thermosetting resin and a coloring material as described in the specific example, a portion in which the coating film 2 is intended to be cured but not to be colored is irradiated with a laser beam having a wavelength which does not color the coloring material. Thus, the coating film in the portion is heated to be cured. On the contrary, a portion in which the coating film 2 is intended to be cured and colored is irradiated with a laser beam of a wavelength which colors the coloring material to thereby change the color of the coating film 2 and which provides a specific color in the coloring material. Thus, the coating film 2 in the portion is heated to be cured. By way of more specific example, when the above-mentioned one is used as the resin composition, a portion in which the coating film 2 is intended to be cured but the coloring material is intended not to be colored can be irradiated with a laser beam by use of a semiconductor laser oscillating apparatus made by Spectra-Physics Inc. under the conditions of wavelength 795 nm, CW (Continuous Wave) oscillation, output 2.5 W, spot diameter ø1.5 mm, scanning speed 2.5 mm/sec, and irradiation time 0.6 sec. Moreover, a portion in which the coating film 2 is intended to be cured and the coloring material is intended to be colored in blue can be irradiated with a laser beam by use of a similar semiconductor laser oscillating apparatus under the conditions of wavelength 470 nm, Q switch frequency (pulse oscillating frequency) 10 Hz, output 2.5 W, spot diameter ø8 mm, scanning speed 30 mm/sec, and pulse length 10 nsec. Moreover, a portion in which the coating film 2 is intended to be cured and the coloring material is intended to be colored in yellow can be irradiated with a laser beam by use of a similar semiconductor laser oscillating apparatus under the conditions of wavelength 575 nm, Q switch frequency 10 Hz, output 2.5W, spot diameter 0 8 mm, scanning speed 30 mm/sec, and pulse length 10 nsec. Further, a portion in which the coating film 2 is intended to be cured and the coloring material is intended to be colored in orange can be irradiated with a laser beam by use of a similar semiconductor laser oscillating apparatus under the conditions of wavelength 650 nm, Q switch frequency 10 Hz, output 2.5 W, spot diameter ø8 mm, scanning speed 30 mm/sec, and pulse length 10 nsec.

The surface decorative layer 3 formed thus is formed to be adhered to the surface of the molding 1, and a desired color is further given in a desired portion. In the example shown in FIG. 1(b), a star-like area 3a in the surface decorative layer 3 having a square shape in plan view is irradiated with a laser beam by which the coloring material is colored. Thus, the surface decorative layer 3 is colored to form a star-like graphic. On the other hand, the remaining area 3b is irradiated with a laser beam by which the coloring material is not colored, so that the remaining area 3b in the surface decorative layer 3 is formed without coloring. The area 3a in which the surface decorative layer 3 is colored can be colored in a single color by irradiating the area 3a with a laser beam having only one kind of wavelength. Alternatively, the area 3a may be divided into a plurality of sub-areas, and the divided sub-areas may be irradiated with laser beams different in wavelength respectively. Thus, the area 3a to be colored can be colored in partially different colors.

Here, when the coating film 2 is irradiated with an energy beam, the coating film 2 is wholly irradiated with the energy beam so as to be wholly cured. Thus, the coating film 2 as a whole can be formed as the surface decorative layer 3. Alternatively, as shown in FIG. 1(b), only a desired portion of the coating film 2 may be partially irradiated with the energy beam so that the surface decorative layer 3 having a desired shape is formed.

When the surface decorative layer 3 having a desired shape has been formed by partial irradiation with the energy beam as shown in FIG. 1(b), air or a water flow is sprayed from a nozzle toward the uncured coating film 2 so as to remove the uncured coating film 2. Thus, the surface decorative layer 3 can be left as shown in FIG. 1(c).

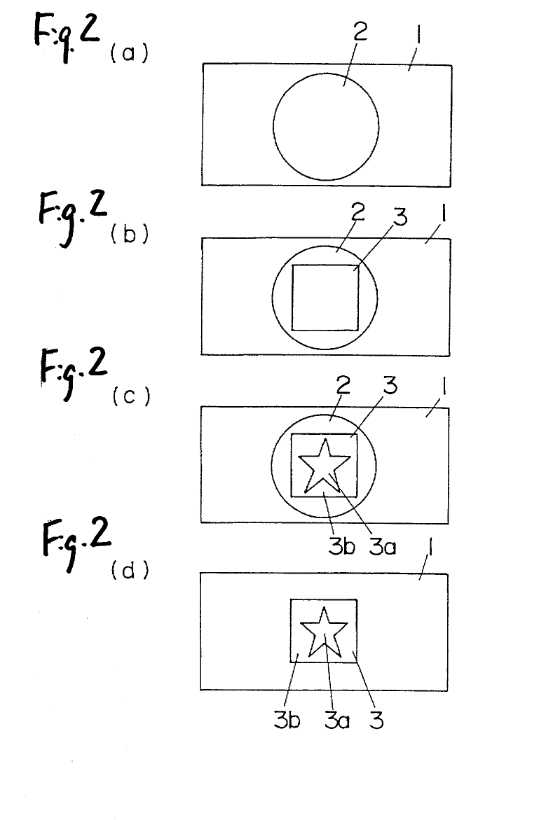

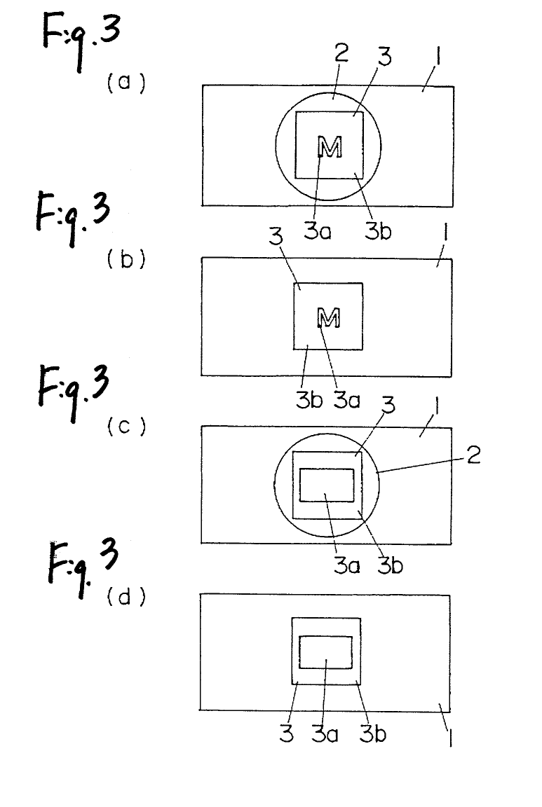

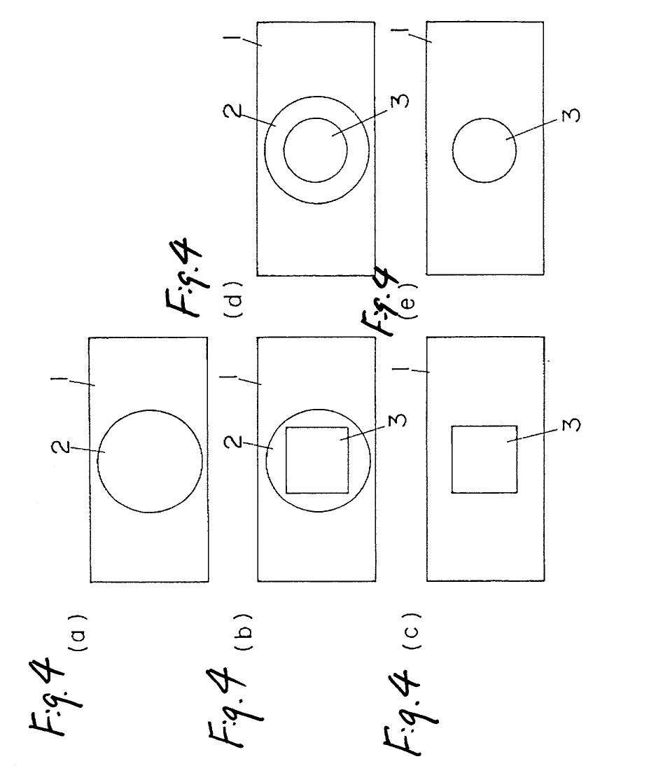

In addition, when a resin composition containing a coloring material as mentioned above is used to form the surface decorative layer 3, the coating film 2 is formed on the molding 1 as shown in FIG. 2(a), in the same manner as mentioned above. After that, in the coating film 2 formed out of this resin composition, an area where the surface decorative layer 3 is to be formed is first irradiated with an energy beam which does not color the coloring material, as shown in FIG. 2(b). Thus, the area is cured without coloring the coating film 2, so as to form the surface decorative layer 3. Further, a desired area 3a of the surface decorative layer 3, for example, a star-like area 3a shown in FIG. 2(c) is irradiated with an energy beam by which the coloring material is colored, so that the desired area 3a in the surface decorative layer 3 is colored. In such a manner, a desired color can be also given in the desired area 3a.

For example, when the resin composition is composed of thermosetting resin and a coloring material as described above by way of specific example, the whole area where the surface decorative layer 3 is to be formed is irradiated with a laser beam having a wavelength which does not color the coloring material. Thus, the coating film 2 is heated to be cured to form the surface decorative layer 3. At this time, the surface decorative layer 3i snot colored. Next, in the surface decorative layer 3, the area 3a intended to be colored is irradiated with a laser beam of a wavelength which colors the coloring material in a specific color. Thus, the surface decorative layer 3 is colored. By way of more specific example, when the above-mentioned one is used as the resin composition, the whole of the area where the coating film 2 is intended to be cured to form the surface decorative layer 3 is first irradiated with a laser beam by use of a semiconductor laser oscillating apparatus made by Spectra-Physics Inc. under the conditions of wavelength 795 nm, CW (Continuous Wave) oscillation, output 2.5 W, spot diameter ø1.5 mm, scanning speed 2.5 mm/sec, and irradiation time 0.6 sec. Next, in the surface decorative layer 3, a portion which is intended to be colored in blue can be irradiated with a laser beam by use of a similar semiconductor laser oscillating apparatus under the conditions of wavelength 470 nm, Q switch frequency 10 Hz, output 2.5 W, spot diameter ø8 mm, scanning speed 30 mm/sec, and pulse length 10 nsec. Moreover, a portion which is intended to be colored in yellow can be irradiated with a laser beam by use of a similar semiconductor laser oscillating apparatus under the conditions of wavelength 575 nm, Q switch frequency 10 Hz, output 2.5 W, spot diameter ø8 mm, scanning speed 30 mm/sec, and pulse length 10 nsec. Further, a portion which is intended to be colored in orange can be irradiated with a laser beam by use of a similar semiconductor laser oscillating apparatus under the conditions of wavelength 650 nm, Q switch frequency 10 Hz, output 2.5 W, spot diameter ø8 mm, scanning speed 30 mm/sec, and pulse length 10 nsec.

In the above-mentioned example shown in FIGS. 1(a) to 1(c) and FIGS. 2(a) to 2(d), the star-like area 3a in the surface decorative layer 3 is irradiated with a laser beam having a wavelength which can color the coloring material, so that the area 3a is colored. However, if an appropriate character or graphic area 3a in the surface decorative layer 3 is irradiated with a laser beam having a wavelength which can color the coloring material, this area 3a is colored so that desired characters, graphics, patterns, etc. can be formed. For example, in an example shown in FIGS. 3(a) and 3(b), after the coating film 2 has been formed on the molding 1, the surface decorative layer 3 is formed such that an M-shaped area 3a of the surface decorative layer 3 is colored while the remaining area 3b is prevented from coloring. Then, the uncured portion of the coating film 2 is removed. On the other hand, in an example shown in FIGS. 3(c) and 3(d), after the coating film 2 has been formed on the molding 1, the surface decorative layer 3 is formed such that an area 3a of the surface decorative layer 3 having a rectangular shape in plan view is colored while the remaining area 3b is prevented from coloring. Then, the uncured portion of the coating film 2 is removed. Even if various characters, graphics, patterns, etc. are formed thus, the area 3a of the surface decorative layer 3 to be colored may be divided into a plurality of sub-areas, and the divided sub-areas may be irradiated with laser beams different in wavelength respectively. Thus, the area 3a to be colored can be colored in partially different colors.

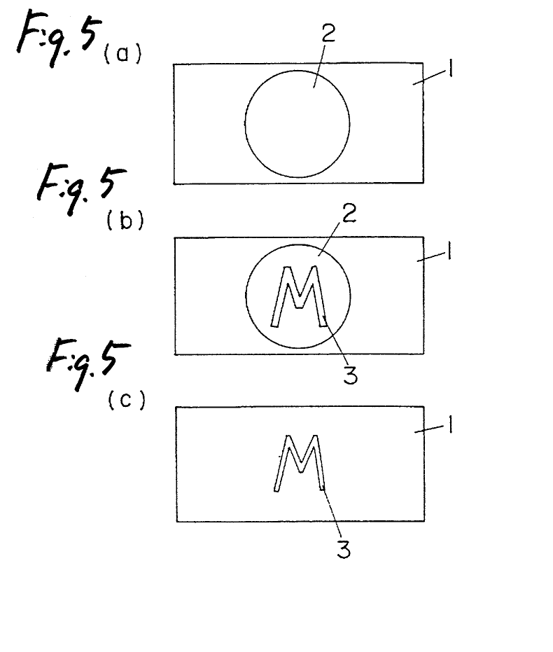

In addition, although the surface decorative layer 3 is formed into a square shape in plan view in each of the above-mentioned examples shown in FIGS. 1(a) to 1(c), FIGS. 2(a) to 2(d), FIGS. 3(a) to 3(d) and FIGS. 4(a) to 4(d), the shape of the surface decorative layer 3 may be also formed into a suitable character or graphic shape. For example, in an example shown in FIGS. 5(a) to 5(c), after the coating film 2 has been formed on the molding 1, the surface decorative layer 3 is formed into an M-shape, and an uncured portion of the coating film 2 is removed.

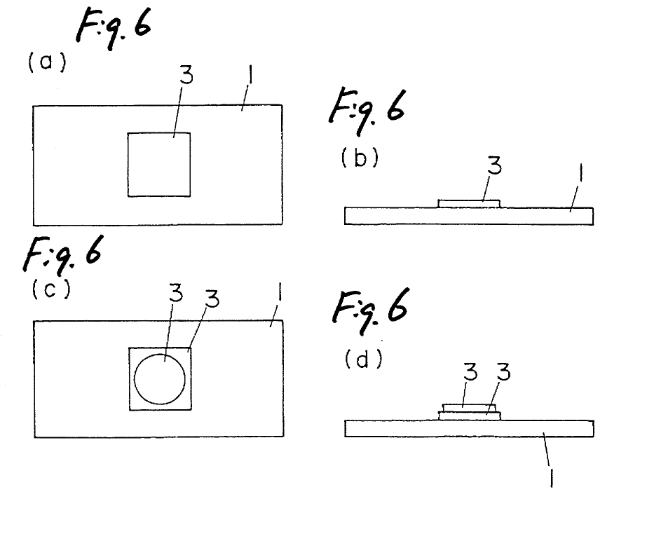

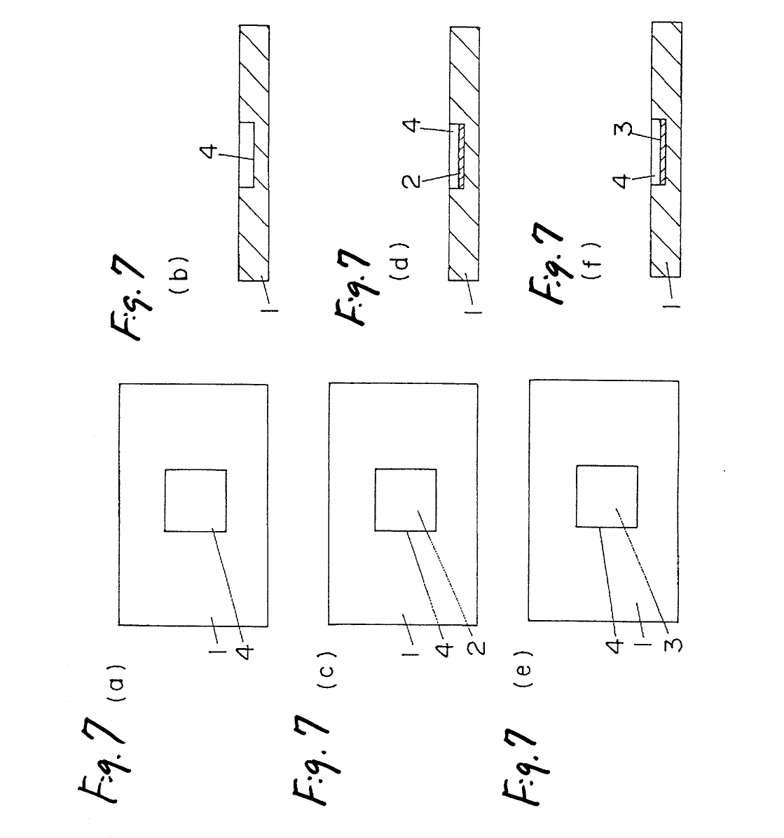

When the surface decorative layer 3 is formed on the surface of the molding 1 in the above-mentioned manner, a plurality of surface decorative layers 3 may be formed to be laminated on the surface of the molding 1. For example, in an example shown in FIGS. 6(a) to 6(d), a first surface decorative layer 3 having a square shape in plan view is first formed on the surface of the molding 1 as shown in FIGS. 6(a) and 6(b). After that, a second surface decorative layer 3 having a square shape in plan view is formed to be laminated onto the upper surface of the first surface decorative layer 3 as shown in FIGS. 6(c) and 6(d). In such a case, characters, patterns, graphics, or the like, composed of different colors and different shapes can be formed by the respective surface decorative layers 3 while these patterns or the like can be formed to be superimposed on one another. Thus, complicated and colorful decoration can be made in combination of the patterns or the like formed by the respective surface decorative layers 3. When a plurality of surface decorative layers 3 are formed in such a manner, a surface decorative layer 3 is cured and formed on the surface of the molding 1 as described above. After that, a similar manner is repeated to form a suitable number of surface decorative layers 3.

In addition, when the surface decorative layer 3 is formed on the surface of the molding 1 as described above, a transparent resin layer may be formed on the surface of the surface decorative layer 3 to cover the surface decorative layer 3. In this case, the surface decorative layer 3 can be protected by the transparent resin layer. Thus, the surface decorative layer 3 is prevented from damage or peeling, so that the decoration exhibited by the surface decorative layer 3 is kept for a long term. In addition, the decoration exhibited by the surface decorative layer 3 can be recognized visually through the transparent resin layer easily.

The transparent resin layer can be formed out of a resin composition similar to the above-mentioned one, except that it contains no coloring matter. When the transparent resin layer is to be formed, the resin composition may be applied to the surface of the surface decorative layer 3 formed on the molding 1, and irradiated with an energy beam for curing the resin composition. Specifically, as such a resin composition for forming the transparent resin layer, the above-mentioned thermoplastics IMC agent (Plaglass #8000 Green) made by DAI NIPPON TORYO CO., LTD. from which coloring matters have been removed can be used by way of example. That is, this agent is a mixture of 100 parts by mass of a base agent and 2 parts by mass of a curing agent. The base agent is composed of 98% by mass of urethane acrylate (containing a crosslinker and a polymerization inhibitor), and 2% by mass of additives such as an internal mold release agent, etc. The curing agent is composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate). In addition, when the coating film 2 formed out of such a resin composition is irradaiated with an energy beam so as to be cured to form the transparent resin layer, for example, irradiation with a laser beam can be performed by use of a semiconductor laser oscillating apparatus made by Spectra-Physics Inc. under the conditions of wavelength 795 nm, CW (Continuous Wave) oscillation, output 2.5 W, spot diameter ø1.5 mm, scanning speed 2.5 mm/sec, and irradiation time 0.6 sec.

In addition, when a thermoplastic resin composition is used as the resin composition, and the coating film 2 composed of the resin composition is irradiated with an energy beam so as to be heated and cured to form the surface decorative layer 3, it is preferable that a heating accelerator is added to the resin composition. In this case, heat generation of the coating film 2 of the resin composition is accelerated when the coating film 2 is irradiated with the energy beam. Thus, the coating film 2 can be cured to form the surface decorative layer 3 in a short time. Accordingly, the working efficiency can be improved. Here, the heating accelerator means a substance having a property to absorb the energy beam such as a laser beam or the like to thereby generate heat.

For example, when a composition described above specifically is used as the resin composition, carbon black or the like can be compounded as the heating accelerator. When the coating film 2 is cured by irradiation with a laser beam without compounding any heating accelerator, the coating film 2 is cured under the condition that the irradiation time of the laser beam is set to 0.6 sec as described above. In comparison therewith, for example, when 0.001 parts by mass of carbon black is compounded per 100 parts by mass of the resin composition, the coating film 2 can be cured to form the surface decorative layer 3 even if the irradiation time of the laser beam is set to 0.3 sec.

In addition, when the surface decorative layer 3 is to be formed in the above-mentioned manner, a recess portion 4 having a desired shape may be formed beforehand on the surface of the molding 1 so as to be opened to the surface side, and the surface decorative layer 3 may be formed in this recess portion 4. In this case, the coating film 2 of the resin composition can be formed to have the same shape as the recess portion 4 by injecting the resin composition into the recess portion 4. By curing this coating film 2, the surface decorative layer 3 having the same shape as the recess portion 4 can be formed easily. Therefore, by forming the shape of the recess portion 4 into a desired shape of the surface decorative layer 3, the surface decorative layer 3 having the desired shape can be formed easily. Thus, it is possible to save the labor with which only a desired portion of the coating film 2 is cured and an uncured portion thereof is removed as described above. In addition, the surface decorative layer 3 to be formed in the recess portion 4 can be formed not to project from the surface of the molding 1. Thus, the surface decorative layer 3 can be prevented from damage due to abrasion or from peeling.

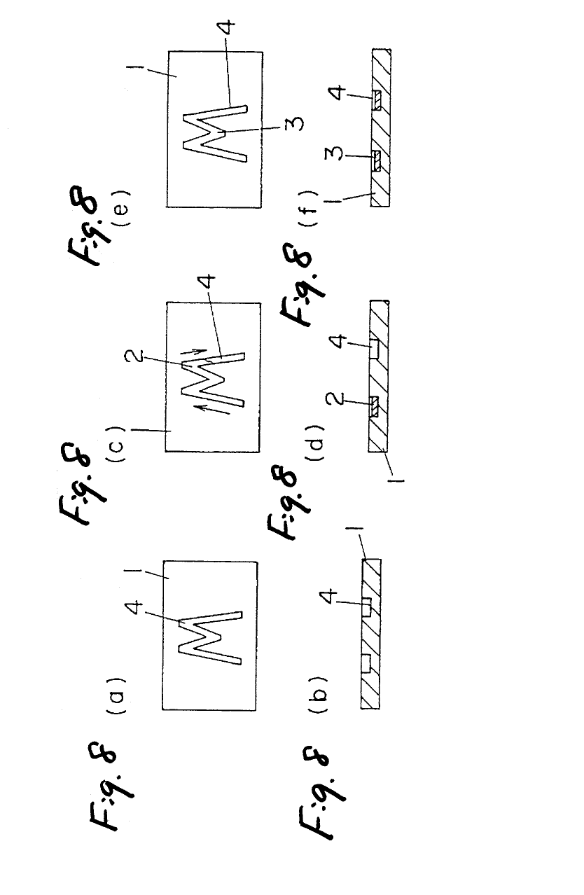

For example, in an example shown in FIGS. 7(a) to 7(f), a molding in which a recess portion 4 having a rectangular shape in plan view has been formed is used as the molding 1 as shown in FIGS. 7(a) and 7(b). The resin composition is injected into the recess portion 4 so as to form a coating film 2 as shown in FIGS. 7(c) and 7(d). Further, the whole area of the coating film 2 is cured to form a surface decorative layer 3 having a rectangular shape in plan view which is the same as the shape, in plan view, of the recess portion 4, as shown in FIGS. 7(e) and 7(f).

On the other hand, in an example shown in FIGS. 8(a) to 8(f), a groove-like recess portion 4 is formed in the molding 1 so as to have an M-shape in plan view as shown in FIGS. 8(a) and 8(b). The resin composition is injected into this recess portion 4 so as to form a coating film 2. At this time, as shown in FIGS. 8(c) and 8(d), the resin composition is injected into the recess portion 4 from one end portion of the groove forming the recess portion 4, so that the resin composition is made to flow from the one end of the groove toward the other end in the recess portion 4. Thus, the coating film 2 can be formed over the whole area in the inside of the recess portion 4. Further, the whole area of the coating film 2 is cured to form a surface decorative layer 3 having an M-shape in plan view which is the same as the shape, in plan view, of the recess portion 4, as shown in FIGS. 8(e) and 8(f).

In addition, when the coating film 2 of the resin composition is irradiated with an energy beam so as to be cured, it is preferable that a light-transmitting member 5 (transparent member) is disposed in contact with the surface of the coating film 2 so that the coating film 2 is irradiated with the energy beam through the light-transmitting member 5. For example, a transparent resin sheet molded out of acrylic resin can be used as the light-transmitting member 5.

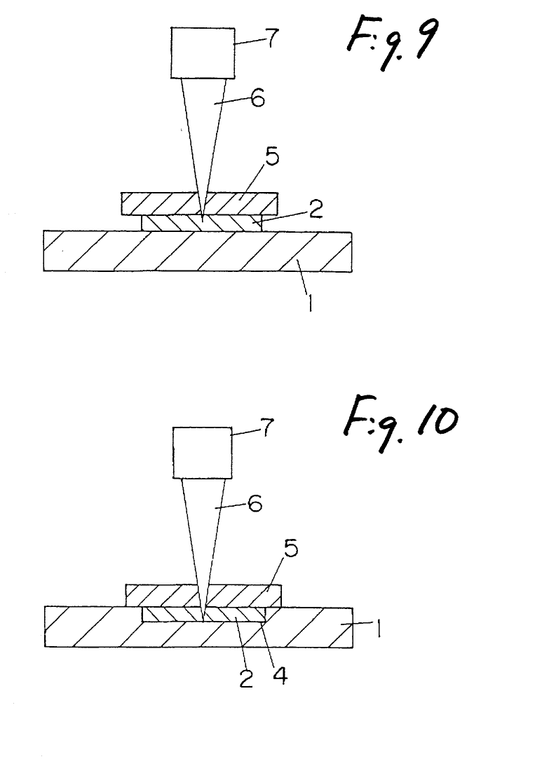

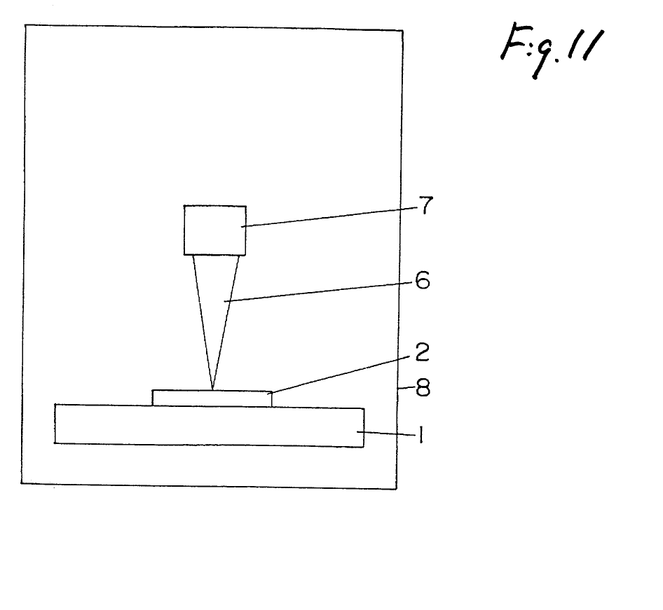

In an example shown in FIG. 9, there is shown an aspect in which the coating film 2 of the resin composition is formed on the surface of the molding 1 having no recess portion 4, and the light-transmitting member 5 is disposed in contact with the surface of the coating film 2 so that the coating film 2 is irradiated with a laser beam 6 from a laser oscillating apparatus 7 through the light-transmitting member 5. On the other hand, in an example shown in FIG. 10, there is shown another aspect in which the resin composition is injected into the recess portion 4 of the molding 1 in which the recess portion 4 has been formed so that the coating film 2 is formed to have a surface in the same plane as the surface of the molding 1, and the light-transmitting member 5 is disposed in contact with the surface of the coating film 2 so that the coating film 2 is irradiated with the laser beam 6 from the laser oscillating apparatus 7 through the light-transmitting member 5. Thus, during the process in which the coating film 2 is cured, the light-transmitting member 5 is in contact with the surface of the coating film 2 or the surface of the surface decorative layer 3 formed by the cured coating film 2. As a result, the thickness of the coating film 2 or the thickness of the surface decorative layer 3 is controlled by the light-transmitting member 5 so that the surface decorative layer 3 can be formed to have a desired thickness. In addition, at this time, the surface decorative layer 3 can be formed to be smooth.

The resin composition described above specifically is cured by radical polymerization. When such a resin composition curable by radical polymerization is used, it is preferable that the coating film 2 of the resin composition is irradiated with an energy beam so as to form the surface decorative layer 3 in the state that the coating film 2 has been disposed in a vacuum or in an inert atmosphere. In such a manner, during the process in which the coating film 2 of the resin composition is cured by radical polymerization, oxygen, or the like, which may inhibit the radical polymerization, is prevented from being supplied to the coating film 2, so that the reaction efficiency of the radical polymerization is improved. Thus, the coating film 2 of the resin composition can be cured to form the surface decorative layer 3 in a shorter time.

When the coating film 2 is to be disposed in a vacuum or in an inert atmosphere as described above, for example, the molding 1 on which the coating film 2 has been formed is disposed in a closed vessel 8 while a vacuum or an inert gas atmosphere is created in the inside of the closed vessel 8. Thus, irradiation with an energy beam can be performed in the closed vessel 8. FIG. 11 shows an aspect in which the coating film 2 on the molding 1 disposed in the closed vessel 8 in a vacuum or an insert gas atmosphere is irradiated with the laser beam 6 by the laser oscillating apparatus 7 so as to form the surface decorative layer 3.

In addition, as shown in FIG. 10, the resin composition may be injected into the recess portion 4 of the molding 1 in which the recess portion 4 has been formed, so that the coating film 2 having a surface in the same plane as the surface of the molding 1 is formed. Then, the light-transmitting member 5 may be disposed in contact with the surface of the coating film 2 so that the coating film 2 is irradiated with an energy beam through the light-transmitting member 5. In this case, the light-transmitting member 5 is disposed all over the surface-side opened end edge of the recess portion 4 so as to close the recess portion 4 with the light-transmitting member 5. Thus, the coating film 2 in the recess portion 4 is blocked from the outside by the light-transmitting member 5 so as to be disposed in a vacuum. Accordingly, with a simple configuration, the coating film 2 can be disposed in a vacuum and accelerated to be cured. In addition, the surface decorative layer 3 formed simultaneously can be smoothed.

It is preferable that the surface decorative layer 3 is formed to be in a range of from 0.1 to 100 μm thick. In this case, when the coating film 2 is cured to form the surface decorative layer 3, the curing is accelerated so that the coating film 2 can be formed efficiently in a short time. Further, sufficient strength is given to the surface decorative layer 3 so that abrasion can be reduced, or the adhesive property between the surface decorative layer 3 and the molding 1 can be improved. In addition, the surface decorative layer 3 is formed not to be thicker than necessary, so that the manufacturing cost can be reduced. Here, if the thickness of the surface decorative layer 3 were larger than 100 μm, it would take much time to cure the coating film 2. In addition, there would be a fear that sufficient strength might be not given to the surface decorative layer 3 formed thus so that the adhesive property between the surface decorative layer 3 and the molding 1 might deteriorate. On the contrary, if the thickness of the surface decorative layer 3 were smaller than 0.1 μm, the color of the surface of the molding 1 which is a base could be visible through the surface decorative layer 3. Thus, the concealability of the surface decorative layer 3 might deteriorate so that the color shown by the coloring of the surface decorative layer 3 might be mixed with the color of the molding 1. Thus, there would be a fear that a desired color could not be obtained.

In addition, when the coating film 2 is formed out of a resin 1 composition, it is preferable that the viscosity of the resin composition immediately before the formation of the coating film 2 is adjusted to be in a range of from 0.1 Pa·s to 1,000 Pa·s, and the coating film 2 is formed out of a resin composition having a viscosity in this range. When a resin composition having a viscosity in this range is used, not only is it possible to ensure sufficient fluidity to form the coating film 2 satisfactorily, but it is also possible to ensure sufficient viscosity to keep the thickness of the coating film. Particularly, in the case where the recess portion 4 is formed in the molding 1 and the surface decorative layer 3 is formed in the recess portion 4, even if the recess portion 4 is formed to have a narrow width to thereby form a minute character, a minute pattern, or the like, in the surface decorative layer 3 as shown in FIGS. 8(a) to 8(f), the resin composition can be made to flow in the recess portion 4 satisfactorily when the resin composition is injected into the recess portion 4. Thus, the coating film 2 can be formed in the recess portion 4 easily. Accordingly, it is possible to prevent a situation that the resin composition does not reach every part of the inside of the recess portion 4 so that the surface decorative layer 3 is not formed to have a sufficient thickness.

### EXAMPLES

The present invention will be described below in detail in accordance with examples.

### Example 1

A thermoplastics IMC agent (Plaglass #8000 Green) made by DAI NIPPON TORYO CO., LTD. was used as a resin composition. This agent was a mixture of 100 parts by mass of a base agent and 2 parts by mass of a curing agent. The base agent was composed of 68% by mass of urethane acrylate (containing a crosslinker and a polymerization inhibitor), 30% by mass of an inorganic compound (cobalt oxide) as pigment, and 2% by mass of additives such as a pigment dispersant, an internal mold release agent, etc. The curing agent was composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate). The viscosity of the mixture was 5 Pa·s.

On the other hand, a plate-like molding 1 measuring 90 mm by 40 mm by 3.0 mm was molded out of ABS resin (made by DAICEL CHEMICAL INDUSTRIES, LTD.; Cevian VF-191).

The above-mentioned resin composition was applied to the surface of the molding 1 by a dispenser so that a coating film 2 having a circular shape in plan view was formed on the surface of the molding 1, as shown in FIG. 4(a).

In this coating film 2, the whole of an area measuring 30 mm by 30 mm was irradiated with a laser beam under the following condition a. Thus, the coating film 2 was cured to form a surface decorative layer 3 as shown in FIG. 4(b).

a. By use of a semiconductor laser oscillating apparatus made by Spectra-Physics Inc., irradiation with a laser beam was performed under the conditions of wavelength 795 nm, CW (Continuous Wave) oscillation, output 2.5 W, spot diameter ø1.5 mm, scanning speed 2.5 mm/sec, and irradiation time 0.6 sec.

Then, after the coating film 2 was cured thus, air was sprayed from a nozzle toward the surface of the molding 1 so as to remove an uncured portion of the coating film 2. Thus, a surface decorative layer 3 measuring 30 mm by 30 mm in plan view and 20 μm thick was formed as shown in FIG. 4(c).

This surface decorative layer 3 showed a color of green.

### Example 2

5 parts by mass of titanium dioxide pigment (made by TOIFINE LTD., Holland; Toifine R41), 0.05 parts by mass of magenta pigment (made by CIBA-GEIGY LTD., Holland; Irgalith Rubine 4BP), 0.05 parts by mass of cyan pigment (made by CIBA-GEIGY LTD., Holland; Irgalith blue LGLD), and 0.05 parts by mass of yellow pigment (made by CIBA-GEIGY LTD., Holland; Cromophal Yellow 6G) were mixed to prepare a coloring material.

Next, a resin composition having a viscosity of 5 Pa·s was prepared by mixing 100 parts by mass of a base agent and 2 parts by mass of a curing agent. The base agent was composed of 68% by mass of urethane acrylate containing a crosslinker and a polymerization inhibitor, 30% by mass of the above-mentioned coloring material, and 2% by mass of additives such as a pigment dispersant, an internal mold release agent, etc. The curing agent was composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate).

This resin composition was applied to the surface of a molding 1 similar to that in Example 1 by a dispenser so that a coating film 2 having a circular shape in plan view was formed as shown 1i in FIG. 1(a).

In this coating film 2, an area measuring 30 mm by 30 mm was further divided into sub-areas, and the respective divided sub-areas were irradiated with a laser beam under the following conditions. Thus, the coating film 2 was cured to form a surface decorative layer 3 as shown in FIG. 1(b).

Here, irradiation with laser beams under the following conditions b to d was carried out in a star-like area 3a of the area measuring 30 mm by 30 mm in the coating film 2 as shown in FIG. 1(b). Irradiation with a laser beam under the condition a was carried out in the remaining area 3b.

a. By use of a semiconductor laser oscillating apparatus made by Spectra-Physics Inc., irradiation with a laser beam was performed under the conditions of wavelength 795 nm, CW (Continuous Wave) oscillation, output 2.5 W, spot diameter ø1.5 mm, scanning speed 2.5 mm/sec, and irradiation time 0.6 sec.

b. By use of the above-mentioned semiconductor laser oscillating apparatus, irradiation with a laser beam was performed under the conditions of wavelength of the laser beam 470 nm, Q switch frequency 10 Hz, output 2.5 W, spot diameter ø8 mm, scanning speed 30 mm/sec, and pulse length 10 nsec.

c. Irradiation with a laser beam was carried out in the same manner as that under the above-mentioned condition b, except that the wavelength of the laser beam was set to 575 nm.

d. Irradiation with a laser beam was carried out in the same manner as that under the above-mentioned condition b, except that the wavelength of the laser beam was set to 650 nm.

Then, after the coating film 2 was cured thus, air was sprayed from a nozzle toward the surface of the molding 1 so as to remove an uncured portion of the coating film 2. Thus, a surface decorative layer 3 measuring 30 mm by 30 mm in plan view and 20 μm thick was formed as shown in FIG. 1(c).

This surface decorative layer 3 showed a black color in the area 3b irradiated with the laser beam under the condition a, a blue color in a portion of the star-like area 3a irradiated with the laser beam under the condition b, a yellow color in a portion of the area 3a irradiated with the laser beam under the condition c, and an orange color in a portion of the area 3a irradiated with the laser beam under the condition d.

### Example 3

A resin composition and a molding 1 similar to those in Example 1 were used.

The resin composition was used to form a coating film 2 having a circular shape, in plan view, on the surface of the molding 1 was formed as shown in FIG. 2(a).

In this coating film 2, the whole of an area measuring 30 mm by 30 mm was irradiated with a laser beam under the following condition. Thus, the coating film 2 was cured to form a surface decorative layer 3 as shown in FIG. 2(b).

a. By use of a semiconductor laser oscillating apparatus i! made by Spectra-Physics Inc., irradiation with the laser beam was performed under the conditions of wavelength 795 nm, CW (Continuous Wave) oscillation, output 2.5 W, spot diameter ø1.5 mm, scanning speed 2.5 mm/sec, and irradiation time 0.6 sec.

Further, in this surface decorative layer 3, a star-like area 3a as shown in FIG. 2(c) was further divided into sub-areas, and the respective divided sub-areas were irradiated with laser beams under the following conditions.

b. By use of the above-mentioned semiconductor laser oscillating apparatus, irradiation with a laser beam was performed under the conditions of wavelength of the laser beam 470 nm, Q switch frequency 10 Hz, output 2.5 W, spot diameter ø8 mm, scanning speed 30 mm/sec, and pulse length 10 nsec.

c. Irradiation with a laser beam was carried out in the same manner as under the above-mentioned condition b, except that the wavelength of the laser beam was set to 575 nm.

d. Irradiation with a laser beam was carried out in the same manner as that under the above-mentioned condition b, except that the wavelength of the laser beam was set to 650 nm.

Then, after the coating film 2 was cured thus, air was sprayed from a nozzle toward the surface of the molding 1 so as to remove an uncured portion of the coating film 2. Thus, a surface decorative layer 3 measuring 30 mm by 30 mm in plan view and 20 μm thick was formed as shown in FIG. 2(d).

This surface decorative layer 3 showed a black color in the area irradiated with the laser beam only under the condition a. In addition, after the star-like area 3a was irradiated with the laser beam under the condition a, the star-like area 3a showed a blue color in a portion further irradiated with the laser beam under the condition b, a yellow color in a portion further irradiated with the laser beam under the condition c, and an orange color in a portion further irradiated with the laser beam under the condition d.

Evaluation

Evaluation for adhesive property was made on each of the surface decorative layers 3 formed in Examples 1 to 3, in a grid taping method based on JIS K 5400 8.5.2. Specifically, each surface decorative layer 3 having a grid pattern was cut into 11 lines vertically and horizontally respectively at intervals of 2 mm with a cutter knife so as to form 100 square grids. After an adhesive tape (made by SEKISUI CHEMICAL CO., LTD.; trade name “Sellotape”) was pasted to the grid portions, the adhesive tape was peeled off. Thus, the adhesive property between each surface decorative layer 3 and each molding 1 was evaluated on the basis of the number of the left square grids in the surface decorative layer 3. The result is shown in Table 1.

TABLE 1

| | Example 1 | Example 2 | Example 3 |
|---|---|---|---|
| adhesive property | 100/100 | 100/100 | 100/100 |

Incidentally, each denominator in the field of adhesive property evaluation in Table 1 designates the number of square grids formed in the surface decorative layer 3, and each numerator designates the number of the left square grids in the surface decorative layer 3 after the tape was peeled off.

As shown in Table 1, in each of Examples 1 to 3, all the 100 square grids were left. Thus, an excellent adhesive property was confirmed between the surface decorative layer 3 and the molding.

### Example 4

First, as shown in FIGS. 6(a) and 6(b), in the same manner as that in Example 1, a first green surface decorative layer 3 measuring 30 mm by 30 mm by 20 μm was formed on the surface of a molding 1, and an uncured portion of a coating film 2 was removed.

On the other hand, a resin composition having a viscosity of 5 Pa·s was prepared to have a composition similar to that in Example 2 except that iron oxide was used as pigment. This resin composition was applied to the surface of the first surface decorative layer 3 so that a coating film 2 having a circular shape in plan view was formed. The whole area of the coating film 2 was irradiated with a laser beam under the following condition. Thus, the coating film 2 was cured to form a second surface decorative layer 3 which was circular and 20 μm thick, as shown in FIGS. 6(c) and 6(d).

a. By use of a semiconductor laser oscillating apparatus made by Spectra-Physics Inc., irradiation with the laser beam was performed under the conditions of wavelength 795 nm, CW (Continuous Wave) oscillation, output 2.5 W, spot diameter ø1.5 mm, scanning speed 2.5 mm/sec, and irradiation time 0.6 sec.

The second surface decorative layer 3 showed a red color.

Evaluation

In Example 4, a pattern in which a red circular graphic was disposed in a green square graphic was formed by the first surface decorative layer 3 having a green color and the second surface decorative layer 3 having a red color. Thus, such a pattern composed of a plurality of colors could be formed easily.

### Example 5

First, as shown in FIGS. 6(a) and 6(b), in the same manner as that in Example 1, a green surface decorative layer 3 measuring 30 mm by 30 mm by 20 μm was formed on the surface of a molding 1, and an uncured portion of a coating film 2 was removed.

On the other hand, a resin composition for a transparent resin layer was prepared by a mixture of 100 parts by mass of a base agent and 2 parts by mass of a curing agent. The base agent was composed of 98% by mass of urethane acrylate (containing a crosslinker and a polymerization inhibitor), and 2% by mass of additives such as an internal mold release agent, etc. The curing agent was composed of 50% by mass of organic peroxide (bis(4-t-butyl cyclohexyl) peroxydicarbonate; Perkadox 16 made by KAYAKU AKZO CO., LTD.) and 50% by mass of plasticizing solvent (dibutyl phthalate).

This resin composition was applied to the whole of the upper surface of the first surface decorative layer 3 so as to form a coating film 2. The whole area of the coating film 2 was irradiated with a laser beam under the following condition. Thus, the coating film 2 was cured to form a transparent resin layer 20 μm thick all over the upper surface of the surface decorative layer 3.

a. By use of a semiconductor laser oscillating apparatus made by Spectra-Physics Inc., irradiation with the laser beam was performed under the conditions of wavelength 795 nm, CW (Continuous Wave) oscillation, output 2.5 W, spot diameter ø1.5 mm, scanning speed 2.5 mm/sec, and irradiation time 0.6 sec.

Evaluation

16 sheets of gauze put on top of one another were laminated on the upper surface of the surface decorative layer 3 formed in Example 1 and covered with no transparent resin layer, and on the upper surface of the surface decorative layer 3 formed in Example 5 and covered with the transparent resin layer, respectively. A load of 9.8 N (lkgf) by a clockmeter was imposed on each of the surface decorative layers 3 through the sheets of gauze so that the surface decorative layers 3 were rubbed by the clockmeter a plurality of times.

As a result, peeling occurred in the surface decorative layer 3 in Example 1 when the surface decorative layer 3 was rubbed about 2,000 times by the clockmeter. On the other hand, in Example 5, peeling occurred when the surface decorative layer 3 was rubbed about 5,000 times. Thus, the strength of the surface decorative layer 3 could be improved by forming the transparent resin layer.

### Example 6

A surface decorative layer 3 was formed on a molding 1 in the same manner as that in Example 1, except that 0.01 parts by mass of carbon black as a heating accelerator was compounded per 100 parts by mass of the resin composition.

Evaluation

An adhesion test by a grid taping method as described above was conducted on each of the surface decorative layers 3 in Examples 1 and 6 while the scanning speed in laser irradiation for forming the surface decorative layer 3 was varied to change the laser beam irradiation time. Thus, the laser beam irradiation time required for all of 100 square grids formed in each of the surface decorative layers 3 to be left was investigated.

TABLE 2

| | Example 1 | Example 6 | |
|---|---|---|---|
| heating accelerator | no | carbon black | |
| loading (per 100 parts by mass | — | 0.001 | parts by |
| of coloring composition) | | | mass |
| curing time (laser beam | 0.6 sec | 0.3 | sec |
| irradiation time) | | | |

As is apparent from this result, in Example 6 using a heating accelerator, the coating film 2 could be cured perfectly to form the surface decorative layer 3 even if the time of irradiation with the laser beam was shortened.

### Example 7

A molding 1 which was molded out of ABS resin (made by DAICEL CHEMICAL INDUSTRIES, LTD.; Cevian VF-191) into a plate shape measuring 90 mm by 40 mm by 3.0 mm was used. A recess portion 4 measuring 30 mm by 30 mm in plan view and 1.5 mm deep was formed in the upper surface of the molding 1 as shown in FIGS. 7(a) and 7(b).

In addition, a resin composition similar to that in Example 1 was used.

Then, as shown in FIGS. 7(c) and 7(d), the resin composition was injected into the recess portion 4 of the molding 1 by a dispenser so as to form a coating film 2 in the recess portion 4. This coating film 2 was irradiated with a laser beam under a condition similar to that in Example 1. Thus, a surface decorative layer 3 which was 20 μm thick was formed in the recess portion 4 as shown in FIGS. 7(e) and 7(f).

Evaluation

In Example 7, the surface decorative layer 3 having a desired shape could be formed without removing any uncured portion of the coating film 2.

### Example 8

When a coating film 2 was irradiated with a laser beam, a transparent resin sheet (light-transmitting member 5) made of acrylic resin and 3 mm thick was disposed in contact with the surface of the coating film 2 as shown in FIG. 9. Thus, the coating film was irradiated with a laser beam 6 through this resin sheet. Under a condition similar to that in Example 1 except the above-mentioned point, a surface decorative layer 3 was formed on the surface of a molding 1.

Evaluation

The surfaces of the surface decorative layers 3 formed in Examples 1 and 8 were observed with a surface roughness gauge. Then, a difference between the highest surface roughness and the lowest was derived as relative surface roughness. The result is shown in Table 3.

TABLE 3

| | Example 1 | Example 8 |
|---|---|---|
| transparent member | no | yes |
| relative surface roughness | 1.5 μm | 0.3 μm |
| (difference between the highest | | |
| and the lowest) | | |

As shown in Table 3, it could be confirmed that, when the coating film 2 is cured in the state where the transparent resin sheet was brought into contact with the coating film 2, the relative surface roughness was reduced so that the smoothness of the surface decorative layer 3 could be improved.

### Example 9

A molding 1 which was molded out of ABS resin (made by DAICEL CHEMICAL INDUSTRIES, LTD.; Cevian VF-191) into a plate shape measuring 90 mm by 40 mm by 3.0 mm was used. A recess portion 4 measuring 30 mm by 30 mm in plan view and 20 μm deep was formed n the upper surface of the molding 1.

In addition, a resin composition similar to that in Example 1 was used.

Then, the resin composition was injected into the recess portion 4 of the molding 1 by a dispenser so as to form a coating film 2 which was 20 μm thick in the recess portion 4. Thus, the surface of the coating film 2 was set to be in the same plane as the surface of the molding 1. Then, a transparent resin sheet (light-transmitting member 5) made of acrylic resin and 3 mm thick was disposed on the upper surf ace of the molding 1 so as to cover the recess portion 4 as shown in FIG. 10. At the same time, the resin sheet was brought into contact with the surface of the coating film 2 so that the coating film 2 was blocked from the outside atmosphere. The coating film 2 was irradiated with a laser beam 6 through this resin sheet. Under a condition similar to that in Example 1 except the above-mentioned point, a surface decorative layer 3 was formed on the surface of a molding 1.

Evaluation

Laser beam irradiation time required for curing the coating film 2 perfectly to form the surface decorative layer 3 with sufficient strength was investigated in each of Examples 1 and 9 while the scanning speed in laser irradiation for forming the surface decorative layer 3 was varied to change the laser beam irradiation time. The result is shown in Table 4.

TABLE 4

| | Example 1 | Example 9 |
|---|---|---|
| oxygen supply | yes | no |
| curing time | 0.6 sec | 0.4 sec |
| (laser beam irradiation time) | | |

As is apparent from this result, in Example 9 in which the coating film 2 was blocked from the outside atmosphere by the resin sheet, the coating film 2 could be cured perfectly to form the surface decorative layer 3 even if the time of irradiation with the laser beam 6 was shortened.

### Examples 10-1 to 10-6

Surface decorative layers 3 were formed on the surfaces of moldings 1 in the same manner as that in Example 1, except that the thicknesses of the surface decorative layers 3 formed were changed to be 0.08 μm, 0.1 μm, 1.0 μm, 10 μm, 100 μm and 120 μm respectively.

Evaluation

A grid adhesion test similar to those in Examples 1 to 3 was carried out on each of the surface decorative layers 3 in Examples 10-1 to 10-6. In addition, each of the surface decorative layers 3 was observed visually so that evaluation was made as to whether the base color of the molding 1 could be seen through or not. The result is shown in Table 5.

TABLE 5

| | Examples | | | | | |
|---|---|---|---|---|---|---|
| | 10-1 | 10-2 | 10-3 | 10-4 | 10-5 | 10-6 |
| film thickness | 0.08 | 0.1 | 1.0 | 10 | 100 | 120 |
| (μm) | | | | | | |
| adhesion | 100/100 | 100/100 | 100/100 | 100/100 | 100/100 | 80/100 |
| property | | | | | | |
| concealability | x | ∘ | ∘ | ∘ | ∘ | ∘ |

Incidentally, the symbol “∘” in the field of the concealability evaluation designates that the base color of the molding 1 could not be visible through the surface decorative layer 3. The symbol “×” designates that the base color of the molding 1 could be visible through the surface decorative layer 3.

As is apparent from this result, the adhesive property of the surface decorative layer 3 deteriorated suddenly when the thickness of the surface decorative layer 3 was larger than 100 μm. On the contrary, the concealability deteriorated if the thickness was smaller than 0.1 μm. Thus, it was confirmed that the surface decorative layer 3 had an excellent adhesive strength and an excellent concealability when the thickness was in a range of from 0.1 μm to 100 μm.

### Examples 11-1 to 11-6

By adjusting the loading of the plasticizing solvent (dibutyl phthalate) of the resin composition in Example 1, resin compositions having viscosity of 0.08 Pa·s, 0.1 Pa·s, 10 Pa·s, 100 Pa·s, 1,000 Pa·s, and 1,100 Pa·s, respectively, were prepared.

On the other hand, a molding 1 which was molded out of ABS resin (made by DAICEL CHEMICAL INDUSTRIES, LTD.; Cevian VF-191) into a plate shape measuring 90 mm by 40 mm by 3.0 mm was used. A groove-like recess portion 4 1.0 mm wide and 1.5 mm deep was formed into an M-shape in the upper surface of the molding 1 as shown in FIGS. 8(a) and 8(b)

Then, as shown in FIGS. 8(c) and 8(d), each of the above-mentioned resin compositions was injected from one end of the groove forming the recess portion 4 of the molding 1 so that the resin composition was made to flow in the recess portion 4 and reach every part thereof, to thereby form a coating film 2. The coating film 2 was irradiated with a laser beam under a condition similar to that in Example 1. Thus, the coating film 2 was cured to form a surface decorative layer 3 as shown in FIGS. 8(e) and 8(f).

Evaluation

For each of Examples 11-1 to 11-6, the fluidity of the resin composition when it was injected into the recess portion 4 was evaluated as follows. That is, when the resin composition measured to fill the recess portion 4 was injected from one end of the recess portion 4, visual observation is made as to whether the resin composition reached, or not, every part of the recess portion 4 from the one end to the other end. The symbol “∘” designates that the resin composition reached the other end of the recess portion 4. The symbol “×” designates that the resin composition lost its fluidity before it reached the recess portion 4.

In addition, evaluation for concealability as described above was carried out on each of the surface decorative layers 3 obtained in Examples 11-1 to 11-6. The result is shown in Table 6.

TABLE 6

| | Examples | | | | | |
|---|---|---|---|---|---|---|
| | 11-1 | 11-2 | 11-3 | 11-4 | 11-5 | 11-6 |
| viscosity (Pa · s) | 0.08 | 0.1 | 10 | 100 | 1,000 | 1,100 |
| fluidity | ∘ | ∘ | ∘ | ∘ | ∘ | x |
| concealability | x | ∘ | ∘ | ∘ | ∘ | ∘ |

As is apparent from this result, when the viscosity of the resin composition was larger than 1,000 Pa·s, the fluidity of the resin composition deteriorated so that it became difficult to make the resin composition reach every part of the delicate recess portion 4. On the contrary, if the viscosity was smaller than 0.1 Pa·s, sufficient thickness was not given to the surface decorative layer 3 so that the base of the molding 1 could be visible through the surface decorative layer 3. On the other hand, by adjusting the viscosity of the resin composition to be in a range of from 0.01 Pa·s to 1,000 Pa·s, excellent fluidity could be obtained for 1 the resin composition so that the surface decorative layer 3 formed thus had sufficient thickness. Thus, the concealability was excellent.

### Examples 12-1 and 12-2

Cast iron was used as the material of a molding 1 in Example 12-1, and ceramics (trade name “Accord” made by ISHIHARA CHEMICAL CO., LTD., SiO₂: 46%, MgO: 17%, Al₂O₃: 16%, K₂O: 10%, B₂O₃: 7%, and F: 4%) was used as the material of a molding 1 in Example 12-2. In the same manner as that in Example 1 except the above-mentioned point, a surface decorative layer 3 was formed on the surface of each of the moldings 1.

Evaluation

A grid adhesion test described previously was carried out on each of the surface decorative layers 3 obtained in Examples 1, 12-1 and 12-2. The result is shown in Table 7.

TABLE 7

| | Example 1 | Example 12-1 | Example 12-2 |
|---|---|---|---|
| material of | synthetic | Metal | ceramics |
| molding | resin | | |
| adhesion | 100/100 | 75/100 | 80/100 |
| property | | | |

As is apparent from this result, if the molding 1 was molded out of synthetic resin as that in Example 1, excellent adhesion between the surface decorative layer 3 and the molding 1 was obtained in comparison with that in Example 12-1 in which the molding 1 was molded out of metal or in Example 12-2 in which the molding 1 was molded out of ceramics.

What is claimed is:

1. A method for decorating a molding comprising the steps of:
forming a decorative layer to said molding, said decorative layer being defined by uncured thermosetting resin which can color in a single color or in a plurality of colors in response to irradiation with a laser beam; and
irradiating at least a part of said decorative layer with a laser beam to color said decorative layer in a single color or in a plurality of colors to be decorated.

2. The method for decorating a molding according to claim 1, wherein said decorative layer is cured at the same time of said laser beam irradiation.

3. A method for decorating a molding according to claim 1, further comprising:
irradiating another part of said cured surface decorative layer with a laser beam so that said decorative layer is colored in a single color or in a plurality of colors to be decorated after curing at least a part of said decorative layer by irradiation with a laser beam.

4. A method for decorating a molding according to claim 2, further comprising:
irradiating another part of said cured surface decorative layer with a laser beam so that said decorative layer is colored in a single color or in a plurality of colors to be decorated after curing at least a part of said decorative layer by irradiation with a laser beam.

5. A method for decorating a molding according to claim 1, wherein a plurality of said decorative layers are formed on a surface of said cured decorative layer.

6. A method for decorating a molding according to claim 5, wherein a top surface layer of said decorative layers is transparent.

7. A method for decorating a molding according to claim 1, wherein said thermosetting resin contains a heating accelerator.

8. A method for decorating a molding according to claim 1, wherein, the act of forming includes:
forming a recess portion in said decorative area of said molding, and
injecting a resin for surface decoration into a surface of said recess portion so as to form said decorative layer.

9. A method for decorating a molding according to claim 1,
removing an uncured portion of said decorative layer except a portion heated and cured by laser irradiation.

10. A method for decorating a molding according to claim 1, wherein, and said decorative layer is irradiated with a laser beam through a light-transmitting member brought into contact with said decorative layer.

11. A method for decorating a molding according to claim 1, wherein, when said thermosetting resin is a resin curable by radical polymerization, said decorative layer is heated and cured by irradiation with a laser beam in a vacuum or in an inert gas atmosphere.

12. A method for decorating a molding according to claim 1, wherein a thickness of said decorative layer is formed to be not smaller than 0.1 μm, and not larger than 100 μm.

13. A method for decorating a molding according to claim 1, wherein resin having its viscosity not lower than 0.1 Pa·s and not higher than 500 Pa·s immediately before injection is used as said resin for surface decoration.

14. A method for decorating a molding according to claim 1, wherein said molding is molded out of plastic resin.
